(19) United States
(12) Patent Application Publication
(10) Pub. No.: US 2006/0131082 A1
(43) Pub. Date: Jun. 22, 2006

(54) Travel sized weight scale

(76) Inventor: Moti Shai, Calabasas, CA (US)

Correspondence Address: Moti Shai, 3524 Via Del Prado, Catabasas, CA, 91302, US

(21) Appl. No.: 11/016,590

(22) Filed: Dec. 20, 2004

(51) Int. Cl. G01G 21/00; G01G 19/52; G01G 21/22

(52) U.S. Cl. 177/126; 177/142; 177/253; 177/263

(57) ABSTRACT

A travel sized, compact apparatus which measures the body weight of an individual, comprising a platform small enough to support only one foot of the individual to be weighed; a conversion means for converting the mechanical response signals from the weight of the individual to a display for presenting the measured body weight of the individual. The apparatus is designed to continue to display the individuals' weight after disengaging the device, until a few seconds has lapsed or, after or the individual causes the display to be reset.

### FIELD OF INVENTION

The present invention relates to measurement devices in general and particularly to a compact weight scale suitable for travel purposes.

### BACKGROUND OF THE INVENTION

At the present time, weight scales in the market are crippled with a variety of problems. For instance, they are designed with a platform for two feet and thus typically large in size and inconvenient for travel. The present invention is designed compactly for ease of travel. Imprecision is also another limitation of the available weight scales. For example, when the user is not positioned in the required spot, or changes posture, an incorrect measurement is usually indicated. The conventional scale calculates the weight of an individual by collecting measurements from various points of pressure. Hence the improper placement of a user's foot can result in an incorrect measurement. The current invention utilizes a small area as a platform, thus eliminating the possibility of misplacement of the users foot. Furthermore, the weight of the individual is transferred directly to a single point where the measurement is made. Another unique aspect of the invention is the ability to easily hang from a door lintel while supporting the weight of an adult human. Other weighing devices such as fish weighing scales, lack a foot supporting structure as well as a dedicated component for securing to a door frame lintel. Furthermore fish weighing scales are not designed for greater weighing units such as adult human beings.

### BRIEF DESCRIPTION OF DRAWINGS

FIG. 1-5 relate to the double platform embodiment

FIG. 1 is a side view of the double platform scale clearly showing the arrangement of the platforms, wiring scheme and the hand held display unit

FIG. 2 is a cross sectional view of the coarse measurement platform detailing the interior mechanism of the device

FIG. 3 is a top view of the double platform showing the shape of each platform

FIG. 4 is an elevated view of the arrangement of each platform showing top and bottom plates

FIG. 5 is a side view of the coarse platform under compression from weight of the user

FIG. 6 is a side view of the hanging scale embodiment

FIG. 6b is a cross sectional side view of the hanging scale case

FIG. 6 is a side view of the hanging scale embodiment

FIG. 7 is a perspective view of the hydraulic scale embodiment

FIG. 8 is the top view of the foot platform of the hanging scale embodiment

FIG. 9 is a perspective view of the bottom plate of the hydraulic scale embodiment also showing the jack mechanism and contacts

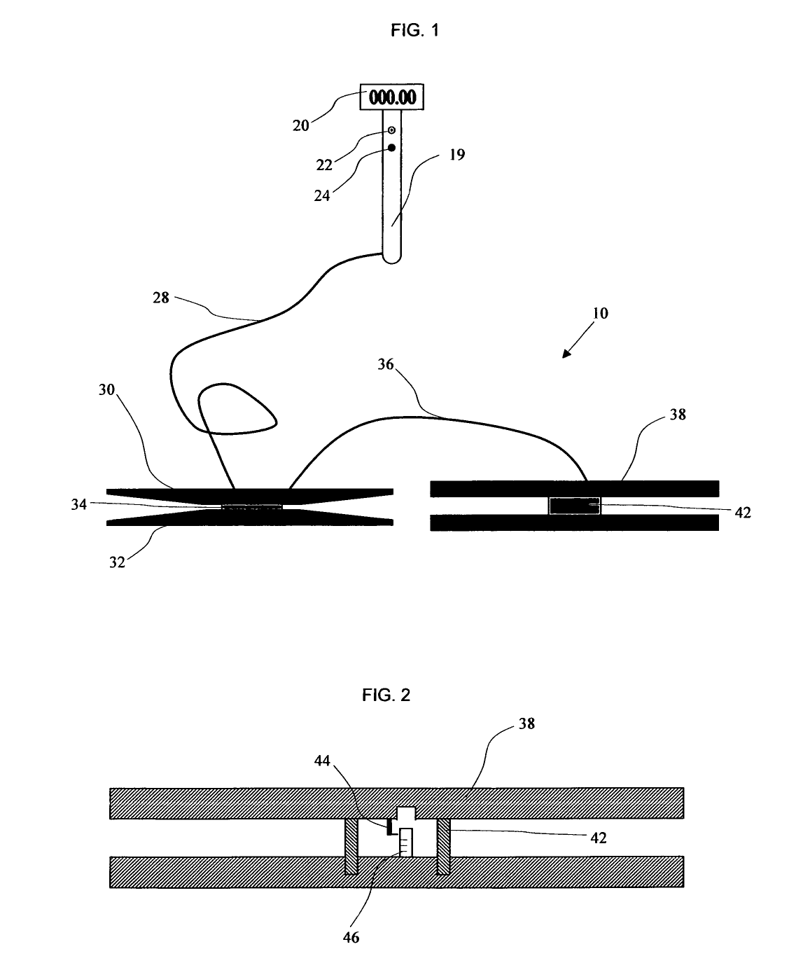

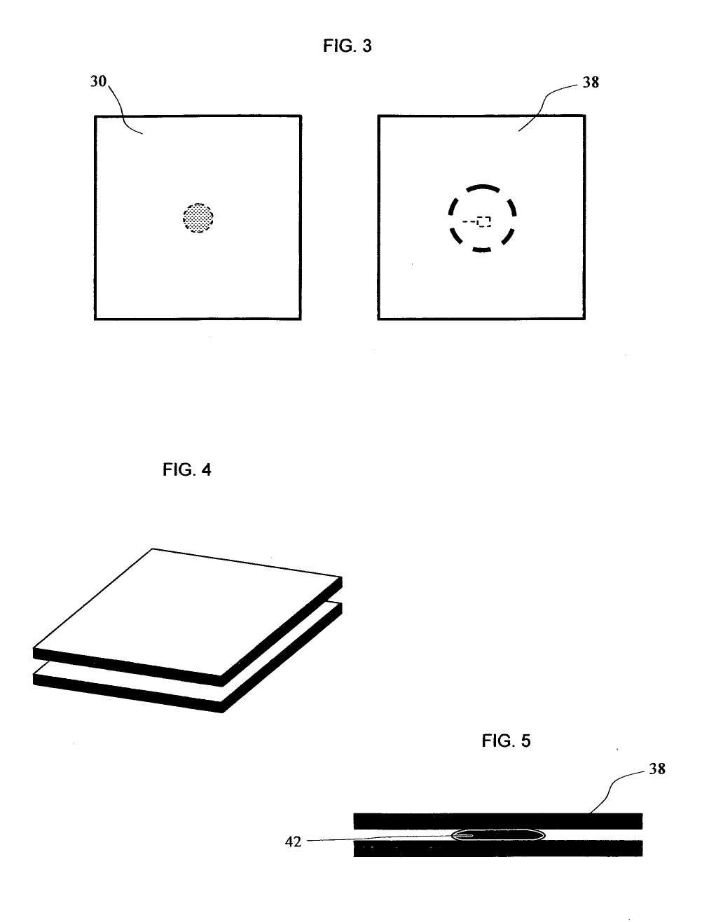

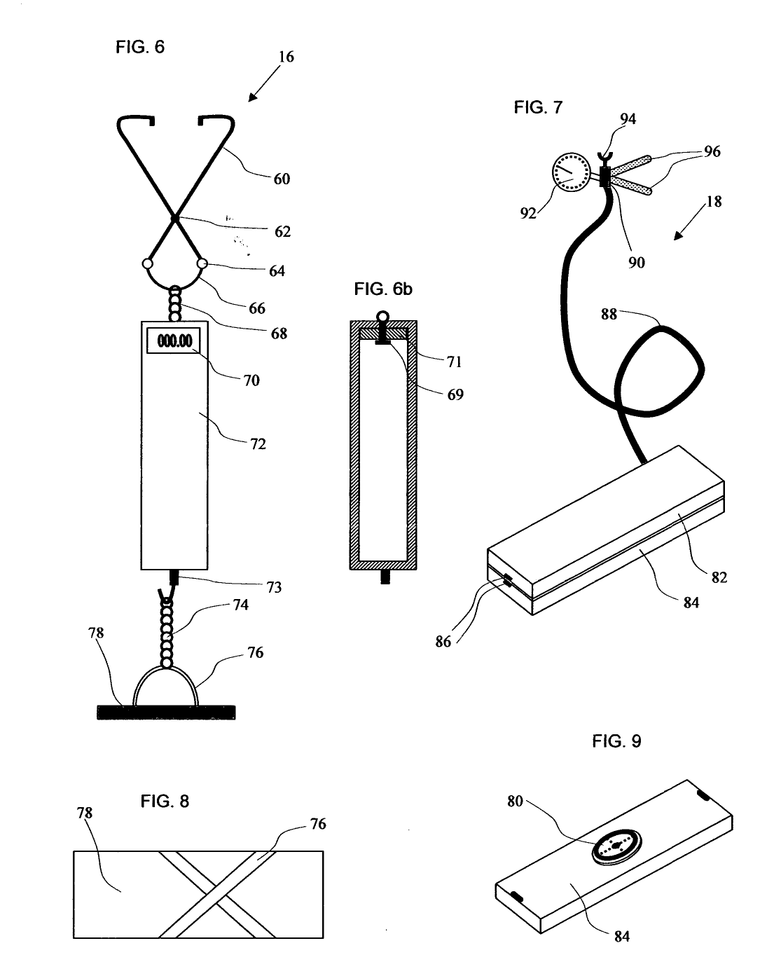

### DETAILED DESCRIPTION OF THE PREFERRED EMBODIMENT

In the first embodiment, the double platform scale (10), the user first places one foot on the coarse measurement platform (38), comprising an elastic element (42), preferably rubber, sandwiched between two plates and a pressure sensor inside the elastic element. Said pressure sensor contains a graduated piece (46) with electric contacts at each mark and a reading piece (44) with an electric contact for engaging and reading said mark. The depressing of the top plate of the coarse measurement platform causes the reading piece to move downward along the graduated piece to obtain a coarse measurement of the individual's weight. This measurement is read when the user places the other foot onto the fine measurement platform which comprises a fine measurement platform top plate (30), a fine measurement bottom plate (32) and a pressure sensing element (34) sandwiched between. The coarse measurement is then transferred to, and combined with the fine measurement reading via a bridging wire (36) and is transferred to the hand held display (19) via the main electric wire (28). The total weight of the individual is displayed the hand held display resulting from the combined measurements of the coarse measurement platform and the fine measurement platform. The hand held display comprises a digital display window (20), a on/off power button, (22) and a reset button (24).

In the second embodiment, the hanging scale (16), a casing (72) is suspended form a door lintel via the doorway lintel hook (60) constructed to include a pivot (62) for proper distancing of the doorway lintel hooks and the rings (64) for supporting a rope (66). Said rope connects on the other end, to the casing at the top portion by chain (68). Casing (72) is hanged on the “T” shaped pin (69) which sandwich the casing (72) and the sensor (71). The bottom portion of said case (72) is connected to the bottom chain (74) via hook (73). The other end of the bottom chain (74) is attached to the foot support (76) which is constructed to hold the foot platform (78). The user operates the scale by securing the doorway lintel hooks (60) to a doorway lintel and placing one foot on the foot platform (78). The weight of the individual is indicated on the digital display (70) when the individual lifts the other foot from the ground thereby transferring all of his/her weight onto the foot platform (78). To assist in balancing, the user may hold on to the casing (72) while maintaining one foot on the foot platform (78). Sensor (71) within the weighting scale operate to sense an applied weight onto the foot platform (78) and generate a signal proportional to the sensed weight which is displayed on the digital display (70).

In the third embodiment, the hydraulic scale (18), is operated by placing all of ones weight on one foot while standing on the top platform (82). The user then brings the pumping handles (96) repeatedly together in a pumping motion, thereby distancing the top platform form the bottom plate (84) via the jack (80). Separation of the plates also separates the contacts (86) activating a solenoid valve thereby blocking flow of hydraulic fluid to the pressure hose/wire cable (88) and hand pump body (90) to lock the pumping handles. The weight of the user is then properly indicated on the scale gauge (92). Pressure may be released by turning the pressure release knob (94) to reset the scale gauge reading.

1. A compact weight scale constructed to hang from a doorframe lintel while also supporting, weighing and indicating the proper weight of an individual comprising:
A case with an internal cavity for housing a load cell, situated to receive the force produced when said case pulled downward due to the weight of an individual, and outputting an electric signal corresponding to the weight of an individual;
A digital display coupled to said load cell for receiving said electric signal and producing a digital display indicating the weight of an individual;
A doorway lintel hook attached to the top portion of a load cell located inside said case for vertical support of said scale;
A support structure for supporting the weight of an individual attached to the bottom portion of said case.

2. The weight scale of claim 1 wherein said support structure is a foot platform and foot support providing sufficient space and support for one foot of an individual

3. A compact weight scale with a digital display for determining and indicating the weight of a person comprising:
A first platform means for supporting one foot of a person, obtaining a coarse measurement of the person's weight and outputting a signal corresponding to said measurement;
A second platform means coupled to said first platform means for supporting one foot of a person, receiving said signal from said first platform, obtaining a fine measurement of a person's weight and outputting a combined signal corresponding accurately to a person's weight;
A digital display for receiving said combined signal and displaying the person's weight.

4. A compact weight scale according to claim 3 wherein said first platform comprises graduated measurements of at least 10 pound divisions or equivalents thereof.

5. A compact weight scale with an analogue display for supporting one foot of a person, while also determining and displaying the person's weight comprising:
A foot platform for supporting one foot of a person comprising a top and bottom plate with a jack sandwiched between at a central location to enable separation of plates;
Electric contacts attached to the interior surface of said top and bottom plates such that they are in contact when said top and bottom plates are in contact and separated when said plates are separated;
A hand pump to enable pumping of hydraulic fluid into said jack thereby separating said contacts;
A solenoid to enable blocking of hydraulic fluid when said contacts are separated;
A scale gauge attached to said hand pump for displaying the weight of an individual.

6. The weight scale of claim 5 wherein said platform can provide a larger surface area for supporting objects larger than a foot.
